(19) United States
(12) Patent Application Publication
(10) Pub. No.: US 2025/0269641 A1
(43) Pub. Date: Aug. 28, 2025

(54) ELEMENT SUBSTRATE AND PRINT HEAD

(71) Applicant: CANON KABUSHIKI KAISHA, Tokyo (JP)

(72) Inventors: SOICHIRO NAGAMOCHI, Kanagawa (JP); TOSHIO NEGISHI, Kanagawa (JP)

(21) Appl. No.: 19/057,079

(22) Filed: Feb. 19, 2025

(30) Foreign Application Priority Data
Feb. 22, 2024 (JP) 2024-025384

(51) Int. Cl. B41J 2/045

(52) U.S. Cl. CPC B41J 2/04541; B41J 2/04528; B41J 2202/13

(57) ABSTRACT

An object is to provide an element substrate that can be prevented from increasing in size. An element substrate includes a plurality of energy generation elements to generate energy for ejection of a liquid, a plurality of heating elements to regulate the temperature of the liquid, first drivers to respectively drive the plurality of energy generation elements, and second drivers to respectively drive the plurality of heating elements. The plurality of energy generation elements, the plurality of heating elements, the first drivers, and the second drivers are arranged along a first direction. A single driver array in which the first drivers and the second drivers are arranged along the first direction is formed.

### BACKGROUND

### Field of the Disclosure

The present disclosure relates to an element substrate, and a print head.

### Description of the Related Art

Japanese Patent Laid-Open No. 2017-213874 discloses a printing element substrate (element substrate) including a supply port provided between a heat source (sub-heater) and another heat source (driver) different from the former heat source. The printing element substrate in Japanese Patent Laid-Open No. 2017-213874 achieves highly reliable driving because an influence of heating on the driver is reduced owing to an increased distance reserved between the heat sources, namely, the sub-heater and the driver.

### SUMMARY

The printing element substrate disclosed in Japanese Patent Laid-Open No. 2017-213874 includes a heater for generating ejection energy in addition to the sub-heater, and additionally requires a driver to drive this heater. Although Japanese Patent Laid-Open No. 2017-213874 does not disclose a position for arranging the driver for driving the heater for generating the ejection energy, the printing element substrate may be increased in size depending on a position for arranging the driver.

The present disclosure has an object to provide an element substrate that can be prevented from increasing in size.

The present disclosure is an element substrate including: a plurality of energy generation elements configured to generate energy for ejection of a liquid; a plurality of heating elements configured to regulate a temperature of the liquid, a plurality of first drivers configured to respectively drive the plurality of energy generation elements; and a plurality of second drivers configured to respectively drive the plurality of heating elements, wherein the plurality of energy generation elements, the plurality of heating elements, the first drivers, and the second drivers are arranged along a first direction, and a single driver array in which the first drivers and the second drivers are arranged along the first direction is formed.

Further features of the present disclosure will become apparent from the following description of exemplary embodiments with reference to the attached drawings.

### BRIEF DESCRIPTION OF THE DRAWINGS

FIG. 1A is a perspective view illustrating an example of a printing apparatus which is applicable to an embodiment;

FIG. 1B is an external perspective view illustrating an example of a cartridge which is applicable to an embodiment;

FIG. 1C is a view for explaining a structure of an element substrate;

FIG. 2 is a plan view illustrating an example of a substrate which is applicable to an embodiment;

FIG. 3 is a diagram illustrating an example of a circuit of a substrate which is applicable to an embodiment;

FIG. 4 is a cross-sectional view taken along a IV-IV line in FIG. 2;

FIG. 5 is an enlarged view of a region V in FIG. 2;

FIG. 6 is a schematic cross-sectional view taken along a VI-VI line in FIG. 5;

FIG. 7 is a schematic see-through plan view illustrating an example of a second substrate;

FIG. 8 is a cross-sectional view taken along a VIII-VIII line in FIG. 7;

FIG. 9 is a schematic plan view illustrating an example of a third substrate; and

FIG. 10 is a schematic plan view illustrating an example of a fourth substrate.

### DESCRIPTION OF THE EMBODIMENTS

### First Embodiment

Hereinafter, embodiments will be described with reference to the drawings. The following embodiments are merely examples to which the technique of the present disclosure is applicable, and are not intended to limit the technical scope of the present disclosure.

In the present disclosure, “printing” means not only to form meaningful information (for example, such as characters and graphics which are noticeable to such a degree that humans can perceive them visually), but also to form meaningless information. In addition, in the present disclosure, “printing” broadly means to form an image, a design, a pattern, a structure, a combination of these, or the like on a printing medium or to process a medium.

“Print media” include not only paper for use in general printing apparatuses, but also any media capable of receiving ink, such as cloth, plastic film, metallic plate, glass, ceramic, resin, wood, and leather. The print medium may be any medium on which an image can be formed with liquid droplets impacted. For example, print media made of various materials in various forms, such as paper, cloth, optical disk label surface, plastic sheet, OHP sheet, and envelop, may be used.

The present embodiment will be described on the assumption that ink is used as a liquid. However, the liquid usable in the technique of the present disclosure is not limited to the ink. As the liquid, various printing solutions other than the ink may be used, such as treatment solutions to be used for the purposes of improving fixing properties, reducing glossy unevenness, and improving rubfastness of the ink on a printing medium.

In the present embodiment, a printing apparatus using an inkjet printing system will be described as an example. The printing apparatus may be a single-function printer having only a printing function or a multi-function printer having multiple functions such as a printing function, a facsimile function, and a scanning function. The printing apparatus may be an apparatus for manufacturing a color filter, an electronic device, an optical device, a micro-structure, or the like with a predetermined printing system.

### Printing Apparatus 100

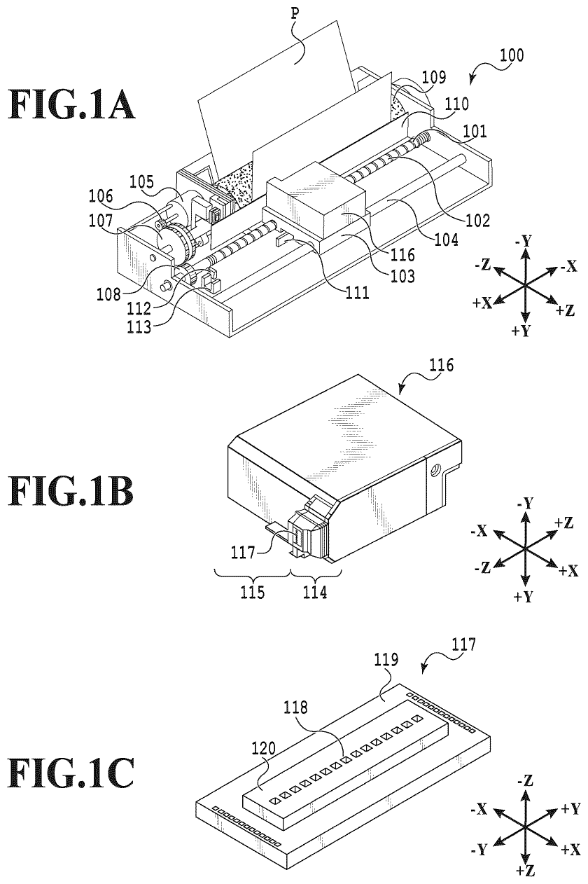

FIG. 1A is a perspective view illustrating a printing apparatus 100 which is applicable to the present embodiment.

As illustrated in FIG. 1A, the printing apparatus 100 includes a lead screw 102 having a spiral groove 101 formed thereon, a carriage 103 having a pin (not illustrated) engaging with the spiral groove 101, and a guide rail 104 configured to support the carriage 103 in a slidable manner.

The printing apparatus 100 includes a carriage motor 105 configured to move the carriage 103 and first, second, and third gears 106, 107, and 108 configured to transmit a driving force from the carriage motor 105 to the lead screw 102.

The printing apparatus 100 includes a platen 109 configured to support a print medium P, and a paper pressing plate 110 configured to press the print medium P. The printing apparatus 100 includes first and second photocouplers 112 and 113 configured to detect a lever 111 attached to the carriage 103.

On the carriage 103, a cartridge 116 in which an inkjet type print head 114 (see FIG. 1B) and an ink tank 115 (see FIG. 1B) are integrated is detachably mounted.

The lead screw 102 is rotated by the driving force from the carriage motor 105 transmitted via the first, second, and third gears 106, 107, and 108. With rotations of the lead screw 102, the carriage 103 having the pin (not illustrated) engaging with the spiral groove 101 formed on the lead screw 102 is moved in ±X directions in FIG. 1A. Specifically, the carriage 103 reciprocates in the ±X directions in FIG. 1A, which are main scanning directions, in conjunction with forward rotational driving and reverse rotational driving by the carriage motor 105. The guide rail 104 supports, from below, the carriage 103 reciprocating in the ±X directions.

On the print medium P, one band of an image is formed with the print head 114 (see FIG. 1B) ejecting the ink according to print data while the carriage 103 is reciprocating in the ±X directions.

A surface of a portion of the print medium P being printed by the print head 114 is kept parallel to an ejection orifice surface of the print head 114 by the platen 109 and the paper pressing plate 110. Upon completion of printing scanning for one band by the print head 114, the print medium P is conveyed in a direction intersecting the X direction (−Y direction in the present embodiment) by a distance equivalent to one band. An image is formed on the print medium P stepwise with alternate repetitions of the printing scanning by the print head 114 and the conveyance operation of the print medium P as described above.

In a scan region of the carriage 103, an end in the +X direction is a home position. In a state where the carriage 103 is located at the home position, the first and second photocouplers 112 and 113 detect the lever 111 attached to the carriage 103. The detection results of the first and second photocouplers 112 and 113 are used for purposes such as switching a rotational direction of the carriage motor 105.

FIG. 1B is an external perspective view illustrating an example of the cartridge 116 which is applicable to the present embodiment.

As illustrated in FIG. 1B, in the cartridge 116, the print head 114 and the ink tank 115 are integrally constructed. The ink to be supplied to the print head 114 is stored inside the ink tank 115.

With the cartridge 116 mounted on the carriage 103 (see FIG. 1A), an electrode (not illustrated) provided in the cartridge 116 is electrically connected to a main-body substrate (not illustrated) of the apparatus. According to ejection signals received by the electrode from the main-body substrate, the ink is ejected from an element substrate 117 of the print head 114.

FIG. 1C is a view for explaining a structure of the element substrate 117, which serves as a section to eject the ink in the print head 114.

As illustrated in FIG. 1C, the element substrate 117 is constructed mainly with an ejection orifice forming member 120 stacked on a substrate 119. In the substrate 119, a plurality of ejection heaters 202 (not illustrated in FIG. 1C), which serve as energy generation elements for ink ejection, are arranged at predetermined intervals in the Y direction in the drawing. The ink is supplied from the ink tank 115 (see FIG. 1B) to the element substrate 117. A temperature sensor (not illustrated) to detect the temperature of the print head 114 (see FIG. 1B) is provided at an end portion on the substrate 119. To obtain the detected temperature, the temperature sensor practically detects the temperature of the ink in contact with the temperature sensor.

In the ejection orifice forming member 120, ejection orifices 118 are formed at positions respectively facing the plurality of ejection heaters 202. These ejection orifices 118 form a single ejection orifice array along the Y direction. This ejection orifice array is configured to print dots at a predetermined print resolution.

In the ejection orifice forming member 120, a plurality of channels (not illustrated) respectively communicating with the ejection orifices 118 and a common liquid chamber (not illustrated) connected to an ink supply port (not illustrated) and connected to the plurality of channels (not illustrated) in common are formed.

In the above structure, the ink supplied from the ink supply port (not illustrated) to the common liquid chamber (not illustrated) is guided to the ejection orifices 118 via the dedicated channels and forms meniscus therein. With application of a predetermined pulse voltage to each of the ejection heaters 202 (not illustrated in FIG. 1C) in accordance with an ejection signal, film boiling occurs in the ink in contact with the ejection heater 202, and the growth energy of the generated bubble causes the ink to be ejected as a droplet from the corresponding ejection orifice 118 in the-Z direction.

Hereinafter, a longitudinal direction (Y direction) of the element substrate 117 will be referred to as a first direction, a short-side direction (X direction) of the element substrate 117 will be referred to as a second direction, and a height direction (Z direction) of the element substrate 117 will be referred to as a third direction as needed. The X direction, the Y direction, and the Z direction are orthogonal to each other.

### Substrate 119

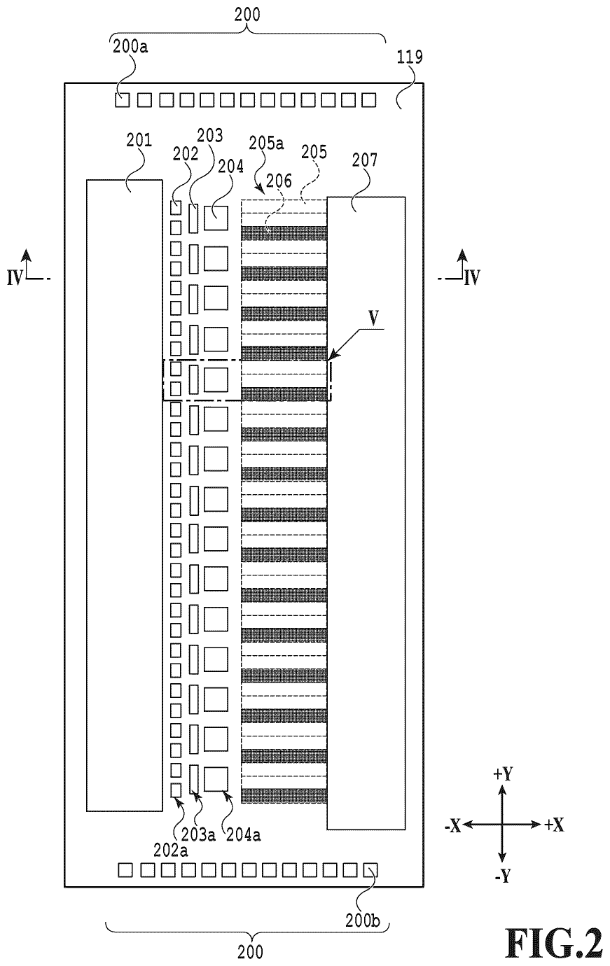

FIG. 2 is a plan view illustrating an example of the substrate 119 which is applicable to the present embodiment.

As illustrated in FIG. 2, the substrate 119 includes pad sections 200 including a power supply pad 200a for electrical connection to the outside and a GND (ground) pad 200b. The substrate 119 includes a VH wiring 201 to function as a power supply wiring. The substrate 119 includes the ejection heaters 202 each capable of generating a bubble in the liquid by being heated, and causing the liquid to be ejected from the corresponding ejection orifice 118 with the growth energy of the bubble, and sub-heaters 203 which are heating elements for regulating the temperature of the liquid by generating heat. The substrate 119 includes supply ports 204 which are openings for supplying the liquid to the ejection orifice forming member 120 (see FIG. 1C).

The substrate 119 includes first drivers 205 configured to drive the ejection heaters 202 and second drivers 206 configured to drive the sub-heaters 203. The substrate 119 includes a GNDH wiring 207 to function as a GND (ground) wiring. Hereinafter, the first drivers 205 and the second drivers 206 will be simply referred to as the drivers unless they have to be distinguished from each other in particular.

In the present embodiment, the plurality of ejection heaters 202 configured to generate energy for ejection of the liquid and the plurality of sub-heaters 203 configured to regulate the temperature of the liquid are arranged along the first direction (Y direction). The first drivers 205 configured to respectively drive the plurality of ejection heaters 202 and the second drivers 206 configured to respectively drive the plurality of sub-heaters 203 are arranged along the first direction (Y direction). In a part of a single driver array 205a formed along the first direction (Y direction), the first driver 205 and the second driver 206 are arranged adjacent to each other along the first direction (Y direction).

In the driver array 205a, the plurality of second drivers 206 are arranged at regular intervals. In the example of FIG. 2, two first drivers 205 are arranged consecutively, and subsequently a single second driver 206 is arranged. In this way, the plurality of sets of two first drivers 205 and a single second driver 206 are arranged along the first direction (Y direction).

An interval between the drivers in the driver array 205a is smaller than an interval between the ejection heaters in an ejection heater array 202a. Specifically, the interval between the two consecutive first drivers 205 and the interval between the consecutive first and second drivers 205 and 206 in the driver array 205a are smaller than the interval between the two consecutive ejection heaters 202 in the ejection heater array 202a.

With this structure, the size of the driver array 205a in the longitudinal direction (Y direction) can be reduced as compared with a case where the interval between the drivers in the driver array 205a is equal to the interval between the ejection heaters in the ejection heater array 202a.

In addition, the interval between the drivers in the driver array 205a is also smaller than an interval between the sub-heaters in a sub-heater array 203a. Specifically, the interval between the two consecutive first drivers 205 and the interval between the consecutive first and second drivers 205 and 206 in the driver array 205a are smaller than the interval between the two consecutive sub-heaters 203 in the sub-heater array 203a.

With this structure, the size of the driver array 205a in the longitudinal direction (Y direction) can be reduced as compared with a case where the interval between the drivers in the driver array 205a is equal to the interval between the sub-heaters in the sub-heater array 203a.

The plurality of supply ports 204 configured to supply the liquid to the plurality of ejection orifices 118 (not illustrated in FIG. 2) are arranged along the first direction (Y direction) at positions corresponding to the plurality of ejection heaters 202, respectively. In the substrate 119, the ejection heater array 202a of the ejection heaters 202, the sub-heater array 203a of the sub-heaters 203, a supply port array 204a formed by the plurality of supply ports 204, and the driver array 205a are arranged along the X direction, which intersects the Y direction in which these arrays are extended.

The pad sections 200 are arranged at both end portions of the substrate 119 in the first direction (Y direction). The pad sections 200 include the power supply pad 200a for the ejection heaters 202 and the sub-heaters 203 and the GND pad 200b for the ejection heaters 202 and the sub-heaters 203. The pad sections 200 include signal pads for transmitting logic data to a control data supply circuit (not illustrated in FIG. 1) and the like.

In a center part of the substrate 119, the plurality of supply ports 204 are arranged along the first direction (Y direction). In other words, in the center part of the substrate 119, the single supply port array 204a including the plurality of supply ports 204 is formed. The supply port array 204a is formed at a position shifted from the ejection heater array 202a in the second direction (+X direction in the example of FIG. 2).

With the ejection orifice forming member 120 stacked on the substrate 119, the liquid supplied from the supply ports 204 is supplied to an upper layer including the ejection heaters 202 via the channels formed in the ejection orifice forming member 120. The plurality of ejection heaters 202 are provided along the first direction (Y direction). In other words, the single ejection heater array 202a including the plurality of ejection heaters 202 is formed along the supply port array 204a.

The sub-heaters 203 are elements configured to heat the substrate 119 and the liquid and keep them warm. The sub-heaters 203 are arranged between the ejection heaters 202 and the supply ports 204 in the X direction. The plurality of sub-heaters 203 are arranged along the first direction (Y direction). In other words, the single sub-heater array 203a is formed between the supply port array 204a and the ejection heater array 202a. With the ejection heater array 202a formed near the sub-heater array 203a as described above, the liquid on the ejection heaters 202 can be heated and kept warm efficiently.

With the sub-heater array 203a formed between the supply port array 204a and the ejection heater array 202a, the liquid on the ejection heaters 202 and inside the supply ports 204 can be also heated and kept warm efficiently. In the present embodiment, the supply port array 204a including the plurality of openings is formed. Instead, one or several supply ports long in the Y direction, each including one opening may be formed.

In addition, the first drivers 205 configured to drive the ejection heaters 202 and the second drivers 206 configured to drive the sub-heaters 203 are arranged in the substrate 119.

In the present embodiment, the plurality of first drivers 205 are respectively and dedicatedly connected to the plurality of ejection heaters 202. The plurality of first drivers 205 form the single driver array 205a along the first direction (Y direction).

By switching each of the first drivers 205 between ON and OFF at desired timing, it is possible to feed a current to the corresponding one of the ejection heaters 202 at the desired timing. With the feeding of the current to the ejection heater 202, the ejection heater 202 is heated and thereby heats the liquid. With the ejection heater 202 heated suddenly, the liquid in contact with the ejection heater 202 causes film boiling and generates a bubble.

The plurality of second drivers 206 are respectively and dedicatedly connected to the plurality of sub-heaters 203. In the driver array 205a in which the plurality of first drivers 205 are arranged in one line along the first direction (Y direction), the second drivers 206 are arranged at regular intervals.

In the present embodiment, two first drivers 205 are arranged consecutively, one second driver 206 is arranged subsequent to these two first drivers 205, and two first drivers 205 are consecutively arranged subsequent to the second driver 206. In this way, in the driver array 205a, the second drivers 206 are located between the two first drivers 205 at the regular intervals. The second drivers 206 are capable of switching a current to be fed to the sub-heaters 203 between ON and OFF. The above layout where the first drivers 205 and the second drivers 206 are arranged in the single driver array 205a makes it possible to save a space without adding an extra array in the X direction.

The VH wiring 201 is arranged in a region left to the ejection heater array 202a. The VH wiring 201 is supplied with a current via the power supply pad 200a. The GNDH wiring 207 is arranged in a region right to the driver array 205a.

The GNDH wiring 207 is connected to the GND pad 200b. The VH wiring 201 is connected to all of the plurality of ejection heaters 202 and the plurality of sub-heaters 203 via dedicated wirings (not illustrated in FIG. 2) and is configured to be usable as a common power supply solid pattern wiring. The GNDH wiring 207 is connected to all of the first drivers 205 and the second drivers 206 and is configured to be usable as a common GND solid pattern wiring.

In order to conserve the power, it is preferable that the power consumed by components other than the ejection heaters 202 and the sub-heaters 203 be as small as possible. For example, it is preferable that the VH wiring 201 and the GNDH wiring 207 be each made of a low resistant material such as aluminum.

As described above, the printing apparatus 100 to print an image on the print medium P (for example, paper) includes the cartridge 116, a scan unit (for example, the carriage 103) configured to cause the cartridge to scan in the scanning directions (X directions), and a conveyer unit (not illustrated) configured to convey the paper in the direction intersecting the scanning directions (see FIG. 1A and so on).

The cartridge 116 includes the print head 114 including the element substrate 117, and the ink tank 115 storing the liquid to be ejected by the print head 114 (see FIG. 1B and so on). The element substrate 117 includes the plurality of energy generation elements configured to generate energy for ejection of the liquid, the plurality of heating elements configured to regulate the temperature of the liquid, the first drivers 205 configured to respectively drive the plurality of energy generation elements, and the second drivers 206 configured to respectively drive the plurality of heating elements. The plurality of energy generation elements, the plurality of heating elements, the first drivers 205, and the second drivers 206 are arranged along the first direction (Y direction). In the substrate 119 of the element substrate 117, the single driver array 205a is formed in which the first drivers 205 and the second drivers 206 are arranged along the first direction.

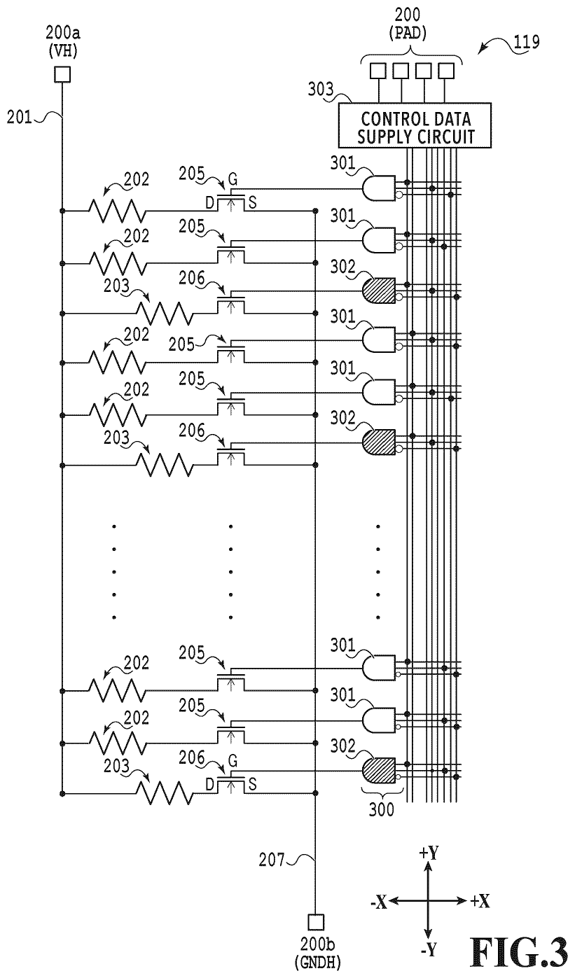

FIG. 3 is a diagram illustrating an example of a circuit of the substrate 119 which is applicable to the present embodiment.

As illustrated in FIG. 3, the first drivers 205 and the second drivers 206 are N-channel insulated-gate field-effect transistors.

The power supply pad 200a is configured to be usable in a manner shared as the same power supply for supplying the power to the ejection heaters 202 and the sub-heaters 203. The power supply pad 200a is connected to the drain sides of the first drivers 205 and the second drivers 206 via the VH wiring 201 and resistors of the ejection heaters 202 and the sub-heaters 203.

The GND pad 200b is configured to be usable in a manner shared as the same GND pad for the ejection heaters 202 and the sub-heaters 203. The GND pad 200b is connected to source sides of the first drivers 205 and the second drivers 206 via the GNDH wiring 207.

In the present embodiment, the VH wiring 201 and the GNDH wiring 207 are used in common to the ejection heaters 202 and the sub-heaters 203. Instead, for power supply, different VH wirings and GNDH wirings and different power supply pads and GND pads may be provided respectively for the ejection heaters 202 and the sub-heaters 203.

In the circuit in the present embodiment, the plurality of first logic circuits (AND circuits) 301 for selecting the ejection heaters 202 are arranged so as to respectively correspond to the plurality of ejection heaters 202. In the present embodiment, an AND circuit is used as the logic circuit. The plurality of first logic circuits 301 are arranged along the first direction (Y direction) to form a logic circuit array 300.

In the circuit in the present embodiment, the plurality of second logic circuits (AND circuits) 302 for selecting the sub-heaters 203 are arranged so as to respectively correspond to the plurality of sub-heaters 203. In the logic circuit array 300 in which the plurality of first logic circuits 301 are arranged in one line along the first direction (Y direction), the second logic circuits 302 are arranged at regular intervals.

In the example of FIG. 3, two first logic circuits 301 are arranged consecutively, a single second logic circuit 302 is arranged subsequent to these two first logic circuits 301, and two first logic circuits 301 are consecutively arranged subsequent to the second logic circuit 302.

The layout where the single logic circuit array 300 is formed by arranging the first logic circuits 301 and the second logic circuits 302 along the Y direction as described above makes it possible to save a space without adding an extra array in the X direction as in the case of the driver array 205a.

Moreover, the first logic circuits 301 and the second logic circuits 302 are connected to the control data supply circuit 303 via signal lines. Based on logic data signals transmitted from the control data supply circuit 303, the two types of the AND circuits and the gates G of the drivers can be controlled, thereby driving the ejection heaters 202 and the sub-heaters 203.

The logic data signals can be input to the control data supply circuit 303 from the pad sections 200 (not illustrated in FIG. 3) via a printing apparatus main body, a host PC (not illustrated), or the like. Examples of the logic data signals include a clock signal CKL, an image data signal DATA, a latch signal LT, and a printing element control signal HE, and so on, all of which are not illustrated.

In the present embodiment, the first logic circuits 301, the second logic circuit 302s, and the control data supply circuit 303 are arranged inside the substrate 119. Instead, the first logic circuits 301, the second logic circuits 302, and the control data supply circuit 303 may be arranged outside the substrate 119.

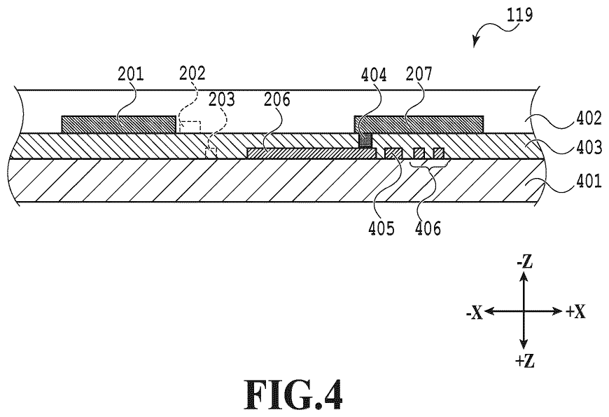

FIG. 4 is a cross-sectional view taken along a IV-IV line in FIG. 2. In FIG. 4, the ejection heater 202 and the sub-heater 203 are illustrated with broken lines because they are arranged on a deeper side in FIG. 4.

As illustrated in FIG. 4, the substrate 119 includes a silicon substrate 401 containing silicon, and an upper layer 402 arranged above the silicon substrate 401. An intermediate layer 403 in which the second driver 206 is arranged is interposed between the silicon substrate 401 and the upper layer 402.

The second driver 206 is arranged on top of the silicon substrate 401. The second driver 206 is covered with an interlayer film functioning as an insulator layer. A portion of the second driver 206 is electrically connected to the GNDH wiring 207 in the upper layer 402 via a through hole 404. In the upper layer 402, the VH wiring 201 is also arranged. The ejection heater 202 is also arranged in the upper layer 402.

The sub-heater 203 is arranged in the intermediate layer 403. The sub-heater 203 is formed of polysilicon, an aluminum wiring, and so on. The intermediate layer 403 includes an AND circuit region 405 where the AND circuits are arranged and a data signal line region 406 where wirings for transmitting and receiving various kinds of data are arranged.

In this way, the substrate 119 includes the silicon substrate 401, the intermediate layer 403, and the upper layer 402 stacked along the direction perpendicular to the surface of the substrate 119. In the substrate 119, the second driver 206 is arranged in the intermediate layer 403 different from the upper layer 402 where the VH wiring 201 and the GNDH wiring 207 are arranged. The second driver 206 is arranged so as to overlap the GNDH wiring 207 along the direction perpendicular to the surface of the substrate 119.

In other words, the GNDH wiring 207 is arranged above the second driver 206 in the third direction (Z direction), which is orthogonal to the first direction (Y direction) and the second direction (X direction), which is orthogonal to the first direction (Y direction) in the plan view. Although the GNDH wiring 207 is arranged above the second driver 206 in the example of FIG. 4, the VH wiring 201 may be arranged above the second driver 206 instead of the GNDH wiring 207.

With this layout, the VH wiring 201 or the GNDH wiring 207 is arranged so as to be shifted from the second driver 206 in the height direction. For this reason, the size of the substrate 119 in the short-side direction can be reduced as compared with a structure where the VH wiring 201, the GNDH wiring 207, and the second drivers 206 are all arranged in the same layer.

Here, the wirings from the VH wiring 201 to the ejection heaters 202 and the sub-heaters 203 and the wirings from the VH wiring 201 to the drivers are routed two-dimensionally or three-dimensionally via through holes, dedicated wirings, and so on.

### Details of First Drivers 205 and Second Drivers 206

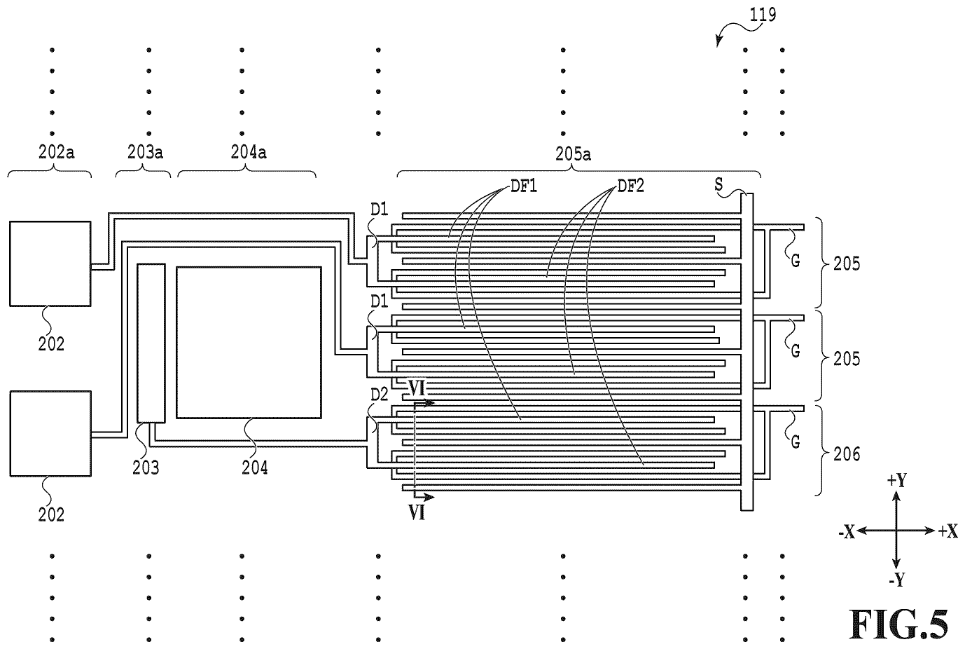

FIG. 5 is an enlarged view of a region Vin FIG. 2. In the present embodiment, the first drivers 205 and the second drivers 206 are n-channel metal-oxide-semiconductors (NMOS) including insulated-gate field-effect transistors.

As illustrated in FIG. 5, a first drain wiring D1 for each first driver 205 is extended from the corresponding ejection heater 202 in the short-side direction (X direction) of the substrate 119 so as to make a detour around the sub-heater 203 and the supply port 204. The first drain wiring D1 is branched, between the supply port 204 and the first driver 205, into two lines apart from each other. The branched two lines of the first drain wiring D1 are extended along the second direction (X direction) in parallel with each other.

In the region V of the present embodiment, two ejection heaters 202 are arranged. Therefore, two first drain wirings D1 are arranged in similar shapes without overlapping each other. A second drain wiring D2 for the second driver 206 is extended from the sub-heater 203 in the short-side direction (X direction) of the substrate 119 so as to be opposed to the first drain wirings D1 across the supply port 204.

The second drain wiring D2 is branched, between the supply port 204 and the second driver 206, into two lines apart from each other. The branched two lines of the second drain wiring D2 are extended along the second direction (the X direction) in parallel with each other. In the plan view of the substrate 119, the first drain wirings D1 and the second drain wiring D2 are arranged in a shape like fingers.

For convenience of description, one of the branched two lines of the first drain wiring D1 and one of the branched two lines of the second drain wiring D2 will be referred to as first fingers DF1. Meanwhile, the other of the branched two lines of the first drain wiring D1 and the other of the branched two lines of the second drain wiring D2 will be referred to as second fingers DF2.

As described above, the two ejection heaters 202 and the single sub-heater 203 are present in the region V in the present embodiment. Then, the first drain wirings D1 are extended respectively from the two ejection heaters 202 and the second drain wiring D2 is extended from the single sub-heater 203. In other words, the two first drain wirings D1 and the single second drain wiring D2 are present in the region V of the present embodiment.

The two first drain wirings D1 and the single second drain wiring D2 are branched in the shape like fingers. Thus, in the driver array 205a of the present embodiment, the three first fingers DF1 and the three second fingers DF2 are alternately arranged along the first direction (Y direction).

Among the three first fingers DF1, two first fingers DF1 connected to the ejection heaters 202 function as electrodes of the first drain wirings D1 in the first drivers 205. Among the three first fingers DF1, the single first finger DF1 connected to the sub-heater 203 functions as an electrode of the second drain wiring D2 in the second driver 206. In short, the total six fingers arranged along the first direction (Y direction) function as the drain side electrodes.

In the present embodiment, a single common source electrode S is arranged for the first drivers 205 and the second drivers 206. The source electrode S is branched into seven fingers, and these seven fingers are laced between the six fingers functioning as the drain side electrodes in an interdigitated manner.

Thus, the fingers functioning as the source side electrodes and the fingers functioning as the drain side electrodes are alternately arranged along the first direction (Y direction). The above layout where the source side electrodes and the drain side electrodes are efficiency arranged makes it possible to reduce the size (width) of the driver array 205a in the second direction.

In the present embodiment, the gates G of the two types of drivers are isolated from each other on a per-driver basis. The gate G is arranged in a hook shape so as to fill spaces between the drain side electrodes and the source side electrodes in each of the drivers. Although there are regions where the gates G overlap the source electrode S and the gates G overlap the first fingers DF1 and the second fingers DF2 in the plan view of the substrate 119, they are electrically isolated from each other by an interlayer insulator film. As described above, a tip end of each of the plurality of gates G is coupled to the corresponding AND circuit among the plurality of AND circuits.

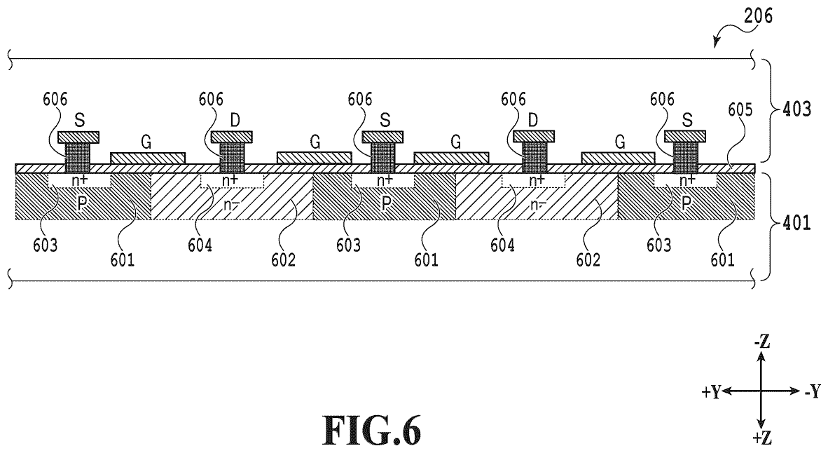

FIG. 6 is a schematic cross-sectional view taken along a VI-VI line in FIG. 5. In FIG. 6, a cross section of the second driver 206 is illustrated to explain a current flow, but the way a current flows in the first driver 205 (not illustrated in FIG. 6) is the same as the way a current flows in the second driver 206.

As illustrated in FIG. 6, the silicon substrate 401 includes p-type base regions 601 and n-type well layers 602 arranged alternately along the first direction (Y direction). Each of the base regions 601 includes an n-type source region 603. Each of the well layers 602 includes an n-type drain region 604. A gate oxide film 605 is laminated on the base regions 601 and the well layers 602. Contact portions 606 are arranged so as to pass through the gate oxide film 605. The contact portions 606 connect the source regions 603 to the source electrode S, the drain region 604 to the second finger DF2, and the drain region 604 to the first finger DF1.

The source electrode S and a drain electrode D in a driver region are electrically connected via the contact portions 606 to the source regions 603 and the drain regions 604 in the silicon substrate 401 serving as a lower layer. In this structure, with application of a predetermined voltage to the gate G, the driver is turned ON and a drain current is allowed to flow between the source and the drain by using, as channels, the p-type base regions 601 located below the gate G.

As described above, in the element substrate in the present embodiment, the second drivers are incorporated in the driver array where the plurality of first drivers are arranged, so that the single driver array including the first drivers and the second drivers is formed. In other words, in the present embodiment, a driver array only including the plurality of first drivers and a driver array only including second drivers are arranged in the same line. In this way, in the present embodiment, the two types of drivers are arranged in a space for arranging a single driver array, so that the size of the element substrate can be reduced as compared with the related art.

As a result, according to the element substrate in the present embodiment, it is possible to prevent the element substrate from increasing in size.

Moreover, in the element substrate in the present embodiment, the supply ports are arranged between the region where the ejection heaters and the sub-heaters are arranged and the region where the first drivers and the second drivers are arranged. This also make it possible to eject the liquid stably by reducing the influence of the heat generated in the ejection heaters and the sub-heaters on the drivers.

### Second Embodiment

The present embodiment has an object to provide an element substrate whose size in the short-side direction can be further deduced. Here, different points from those in the first embodiment will be mainly described while the constituents same as or corresponding to those in the first embodiment will be denoted with the same reference signs, and description thereof will be omitted.

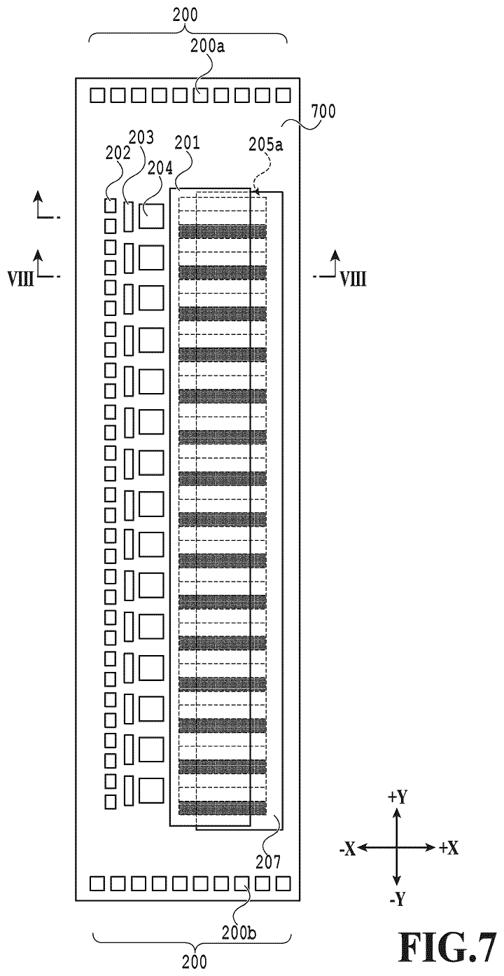

FIG. 7 is a schematic see-through plan view illustrating an example of a second substrate 700 which is applicable to the present embodiment.

As illustrated in FIG. 7, the driver array 205a, the GNDH wiring 207, and the VH wiring 201 are arranged so as to overlap each other in the Z direction in the plan view of the second substrate 700. In the present embodiment, the GNDH wiring 207 and the VH wiring 201 are arranged above the driver array 205a in the overlapping manner as described above. As a result, the second substrate 700 in the present embodiment achieves space saving as compared with the substrate 119 in the first embodiment.

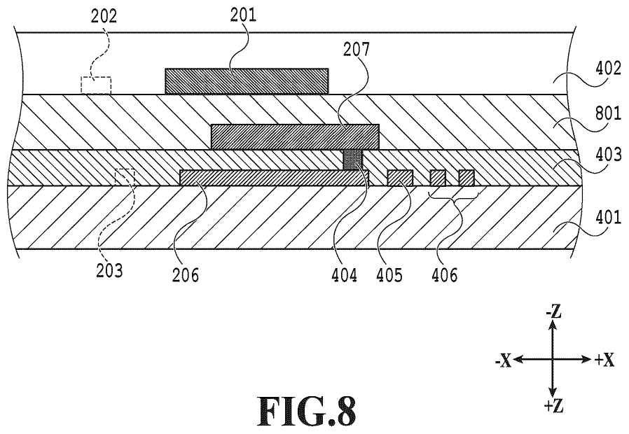

FIG. 8 is a cross-sectional view taken along a VIII-VIII line in FIG. 7.

As illustrated in FIG. 8, the intermediate layer 403 is staked on the silicon substrate 401. In the intermediate layer 403, the sub-heater 203, the second driver 206, a through hole 404, an AND circuit region 405, and the data signal line region 406 are provided.

An intermediate layer 801 including the GNDH wiring 207 is stacked on the intermediate layer 403. The second driver 206 provided in the intermediate layer 403 is connected to the GNDH wiring 207 provided in the intermediate layer 801 via the through hole 404 provided in the intermediate layer 403. The upper layer 402 including the ejection heater 202 and the VH wiring 201 is stacked on the intermediate layer 801.

In this way, in the present embodiment, in the cross-sectional view of the second substrate 700, the driver array, the GNDH wiring 207, and the VH wiring 201 are arranged in the manner overlapping along the third direction (Z direction). This layout achieves a space reduction as compared with the space for lining up the GNDH wiring 207 and the VH wiring 201 along a planar direction (for example, X direction) in the first embodiment. In other words, the layout of the driver array, the GNDH wiring 207, and the VH wiring 201 makes it possible to more save the space for arranging these constituents than in the first embodiment.

Thus, according to the second substrate 700, the size in the short-side direction (X direction) can be made smaller than in the first embodiment.

Although the VH wiring 201 is arranged above the GNDH wiring 207 in the present embodiment, the GNDH wiring 207 may be arranged above the VH wiring 201. This structure also makes it possible to make the size in the short-side direction (X direction) smaller than in the first embodiment.

### Third Embodiment

The present embodiment has an object to provide an element substrate in which a temperature distribution can be regulated with higher accuracy. Here, different points from those in the first and second embodiments will be mainly described while the constituents same as or corresponding to those in the first and second embodiments will be denoted with the same reference signs, and description thereof will be omitted.

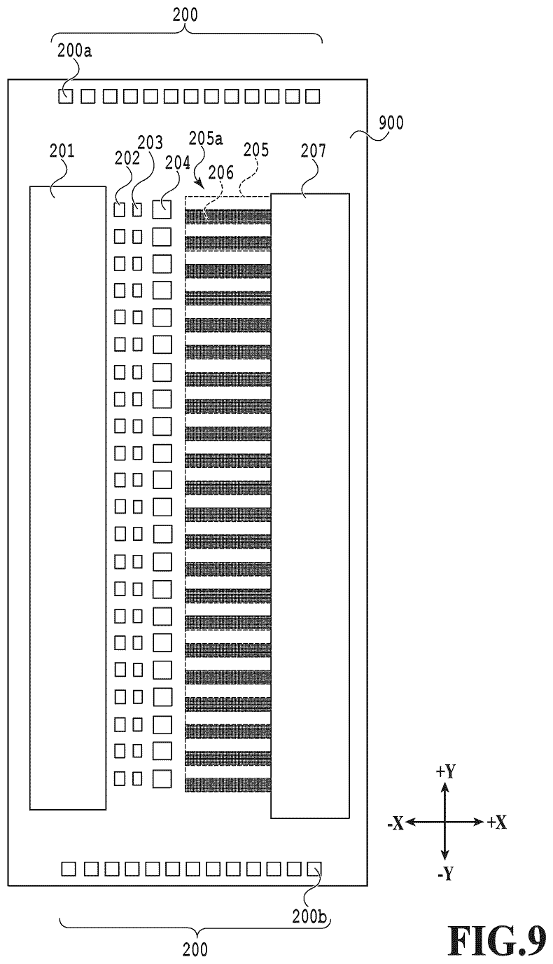

FIG. 9 is a plan view illustrating an example of a third substrate 900 which is applicable to the present embodiment.

As illustrated in FIG. 9, in the third substrate 900, the sub-heaters 203 and the ejection heaters 202 are provided on a one-to-one basis. In the driver array 205a in the third substrate 900, the first drivers 205 and the second drivers 206 are arranged alternately one by one along the first direction (Y direction). In the logic circuit array in the present embodiment, the first logic circuits 301 (see FIG. 3) and the second logic circuits 302 (see FIG. 3) are also alternately arranged along the first direction (Y direction).

Therefore, according to the element substrate in the present embodiment, it is possible to regulate the temperature distribution with higher accuracy than in the first embodiment.

### Fourth Embodiment

The present embodiment has an object to regulate the temperature distribution at end portions of an element substrate with higher accuracy. Here, different points from those in the first, second, and third embodiments will be mainly described while the constituents same as or corresponding to those in the first, second, and third embodiments will be denoted with the same reference signs, and description thereof will be omitted.

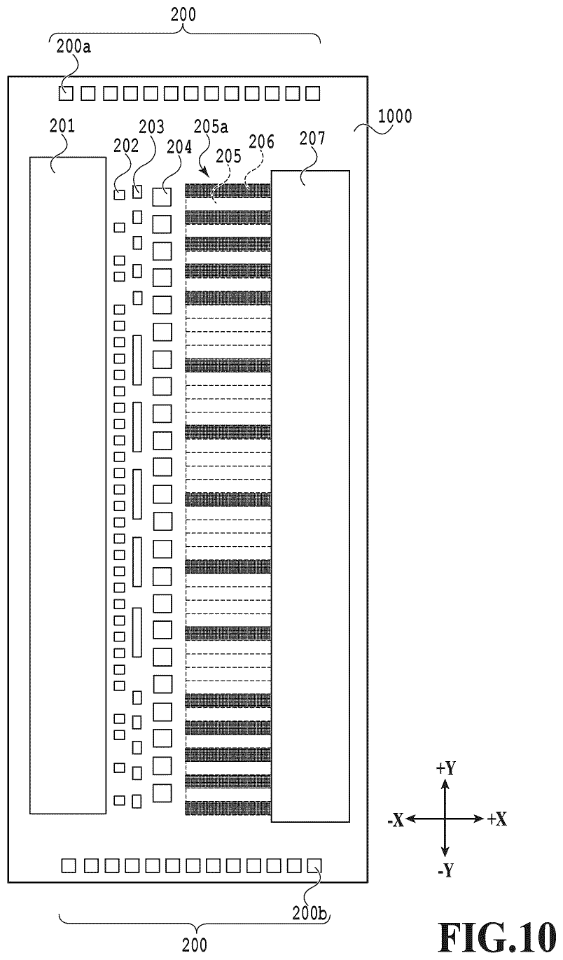

FIG. 10 is a plan view illustrating an example of a fourth substrate 1000 which is applicable to the present embodiment.

As illustrated in FIG. 10, at a center portion of the fourth substrate 1000, the sub-heaters 203 and the second drivers 206 are arranged more sparsely than in the first embodiment. At end portions of the fourth substrate 1000, the sub-heaters 203 and the second drivers 206 are arranged more densely than at the center portion of the fourth substrate 1000.

In general, the end portions of an element substrate are more susceptible to a change in the outside temperature than the center portion of the element substrate. Therefore, the layout where the sub-heaters 203 and the second drivers 206 are arranged gradually more densely as they approach the end portions from the center portion as in the fourth substrate 1000 makes it possible to correct a change in the temperature at the end portions of the element substrate with higher accuracy.

Note that, in the driver array 205a in the present embodiment, the ratio of the number of ejection heaters 202 to one sub-heater 203 at the central portion is different from the ratio of the number of ejection heaters 202 to one sub-heater 203 at the end portions. Even in the case where the ratio of the number of ejection heaters 202 to one sub-heater 203 is changed within the single driver array 205a, it is possible to connect the ejection heaters 202 to the first drivers 205 and connect the sub-heaters 203 to the second drivers 206. In this case, for example, with fine drain side wirings arranged, it is possible to easily connect the ejection heaters 202 to the first drivers 205 and connect the sub-heaters 203 to the second drivers 206.

Therefore, according to the element substrate in the present embodiment, it is possible to regulate the temperature distribution at the end portions with higher accuracy than in the first embodiment.

### Other Embodiments

In the first, second, third, and fourth embodiments, the heaters are used as the energy generation elements. Instead, any of various elements such as piezo elements may be used.

According to an element substrate in the present disclosure, it is possible to prevent the element substrate from increasing in size.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-025384, filed Feb. 22, 2024, which is hereby incorporated by reference wherein in its entirety.

What is claimed is:

1. An element substrate comprising:
a plurality of energy generation elements configured to generate energy for ejection of a liquid;
a plurality of heating elements configured to regulate a temperature of the liquid;
a plurality of first drivers configured to respectively drive the plurality of energy generation elements; and
a plurality of second drivers configured to respectively drive the plurality of heating elements, wherein
the plurality of energy generation elements, the plurality of heating elements, the first drivers, and the second drivers are arranged along a first direction, and
a single driver array in which the first drivers and the second drivers are arranged along the first direction is formed.

2. The element substrate according to claim 1, wherein
in the driver array, the plurality of second drivers are arranged at regular intervals along the first direction.

3. The element substrate according to claim 2, wherein
in the driver array, one of the second drivers is arranged subsequent to every two or more consecutive ones of the plurality of first drivers.

4. The element substrate according to claim 2, wherein
in the driver array, the first drivers and the second drivers are alternately arranged.

5. The element substrate according to claim 1, wherein
an interval between the drivers in the driver array is smaller than an interval between the energy generation elements in an energy generation element array including the plurality of energy generation elements.

6. The element substrate according to claim 1, wherein
an energy generation element array including the plurality of energy generation elements and a heating element array including the plurality of heating elements are arranged along a second direction intersecting the first direction.

7. The element substrate according to claim 6, further comprising a plurality of supply ports arranged along the first direction so as to correspond to the plurality of energy generation elements, respectively, and configured to supply the liquid to the plurality of energy generation elements.

8. The element substrate according to claim 7, wherein
a supply port array including the plurality of supply ports is arranged at a position shifted from the energy generation element array in the second direction.

9. The element substrate according to claim 8, wherein
the heating element array is provided between the energy generation element array and the supply port array in the second direction.

10. The element substrate according to claim 1, wherein
the heating elements are arranged more densely at an end portion of a heating element array including the plurality of heating elements than at a center portion of the heating element array.

11. The element substrate according to claim 1, wherein
each of the first drivers and the second drivers includes an insulated-gate field-effect transistor, and
a common source side wiring is connected to drain side wirings of the first drivers and the second drivers.

12. The element substrate according to claim 1, further comprising:
a plurality of first logic circuits arranged along the first direction and configured to select the first drivers; and
a plurality of second logic circuits arranged along the first direction and configured to select the second drivers, wherein
a single logic circuit array in which the first logic circuits and the second logic circuits are arranged along the first direction is formed.

13. The element substrate according to claim 12, wherein
in the logic circuit array, the second logic circuits are arranged at regular intervals in the first direction.

14. The element substrate according to claim 13, wherein
in the logic circuit array, one of the second logic circuits is arranged subsequent to every two or more consecutive ones of the plurality of first logic circuits.

15. The element substrate according to claim 13, wherein
in the logic circuit array, the first logic circuits and the second logic circuits are alternately arranged.

16. The element substrate according to claim 1, wherein
a power supply wiring is provided in common to the heating elements and the energy generation elements.

17. The element substrate according to claim 1, wherein
a ground wiring is provided in common to the heating elements and the energy generation elements.

18. The element substrate according to claim 1, comprising a plurality of layers stacked along a direction perpendicular to a surface of the element substrate, wherein
the second drivers are arranged in a layer different from a layer where a power supply wiring or a ground wiring of the heating elements is arranged, and are arranged so as to overlap the power supply wiring or the ground wiring along the direction perpendicular to the surface of the element substrate.

19. The element substrate according to claim 18, wherein
the second drivers, the ground wiring, and the power supply wiring are arranged so as to overlap each other along the direction perpendicular to the surface of the element substrate.

20. A print head comprising:
an element substrate,
the element substrate including,
a plurality of energy generation elements configured to generate energy for ejection of a liquid,
a plurality of heating elements configured to regulate a temperature of the liquid,
a plurality of first drivers configured to respectively drive the plurality of energy generation elements, and
a plurality of second drivers configured to respectively drive the plurality of heating elements, wherein
the plurality of energy generation elements, the plurality of heating elements, the first drivers, and the second drivers are arranged along a first direction, and
a single driver array in which the first drivers and the second drivers are arranged along the first direction is formed.
